(19) United States
(12) Patent Application Publication
(10) Pub. No.: US 2023/0244208 A1
(43) Pub. Date: Aug. 3, 2023

(54) CONTROL DEVICE HAVING TOOL SETTING MANAGEMENT FUNCTION, CONTROL SYSTEM AND TOOL

(71) Applicant: Fanuc Corporation, Minamitsuru-gun, Yamanashi (JP)

(72) Inventors: Yasuhiro Amagata, Minamitsuru-gun, Yamanashi (JP); Shigeo Yoshida, Minamitsuru-gun, Yamanashi (JP); Akinori Nishimura, Minamitsuru-gun, Yamanashi (JP); Sayuki Kashiwagi, Minamitsuru-gun, Yamanashi (JP)

(73) Assignee: Fanuc Corporation, Minamitsuru-gun, Yamanashi (JP)

(21) Appl. No.: 18/009,816

(22) PCT Filed: Jun. 9, 2021
(86) PCT No.: PCT/JP2021/021944

§ 371 Date: Dec. 12, 2022

(30) Foreign Application Priority Data
Jun. 16, 2020 (JP) 2020-103755

(51) Int. Cl. G05B 19/4093

(52) U.S. Cl. CPC G05B 19/40938

(57) ABSTRACT

A control device controls a tool having a memory and removably attached to a machine. The control device includes a tool information reading unit that reads at least one of tool setting information and tool status information written in the memory of the tool, and a tool setting unit that sets the tool on the basis of at least one of the read tool setting information and tool status information. The tool is driven by a motor having an encoder, and the memory is attached to the encoder.

### CROSS REFERENCE TO RELATED APPLICATIONS

This is the U.S. National Phase application of PCT/JP2021/021944, filed Jun. 9, 2021, which claims priority to Japanese Patent Application No. 2020-103755, filed Jun. 16, 2020, the disclosures of these applications being incorporated herein by reference in their entireties for all purposes.

### FIELD OF THE INVENTION

The present invention relates to a technique for setting or managing a tool, and in particular, to a control device having a tool setting management function, a machine system, and a tool.

### BACKGROUND OF THE INVENTION

Some types of tools, attached to a machine such as a robot and a machine tool, are driven by motors, and the tools may also be controlled by a controller of the machine. In such a case, it is necessary to previously set various information of the tool in the controller in order to correctly operate the tool by the controller. For example, in a spot welding gun driven by a servomotor, tool-related parameters are previously set, as well as motor-related parameters such as a reduction ratio, a pressing force, and a maximum opening amount between electrode tips. In the prior art, it is necessary to obtain such tool setting information from a tool manufacturer and set it in the controller. The following documents are known as describing techniques related to such setting or management of the machine.

Patent Literature 1 describes that a memory is provided in a mechanical unit such as a robot mechanical unit or a wrist which constitutes the robot mechanical unit, the memory previously stores stored information including a parameter unique to each robot mechanical unit or mechanical unit and used for trajectory control in the robot controller and/or information reflected in the parameter, and operations for changing various data after replacement of the robot mechanical unit or the mechanical unit are automated by reading the stored information into the robot controller. It is also described that the memory is a non-volatile memory attached to an encoder.

Patent Literature 2 describes a tool data management device including: a data storage device arranged in a tool shank to which a tool is fixed and configured to hold tool data and output the data; and a data input/output means fixed to a machine tool and configured to receive the data from the data storage device and provide the data to a controller of the machine tool, and configured to transfer predetermined tool data to the data storage device under control of the machine tool.

Patent Literature 3 describes a robot system constituted by a robot body and a controller for controlling the robot body using unique data which is initial setting information of the robot body, wherein each of the robot body and the controller stores unique data, the controller reads out the unique data stored in the robot body and collates it with the unique data stored in the controller, so that the robot system can be controlled by the controller even when a built-in board of the robot body is replaced. Further, it is described that an operation history and maintenance information are also stored in the memories of the robot body and the controller.

### PATENT LITERATURE

[PTL 1] JP 2004-148433 A
[PTL 2] JP 1987(S62)-63050 A
[PTL 3] JP 2001-242922 A

### SUMMARY OF THE INVENTION

As a means for simplifying the tool setting, a method of previously preparing a file in which the tool setting information is stored and reading the file by the controller may be used. However, there is a demerit in that it is necessary to previously prepare the file storing the tool setting information, and it is also necessary to manage the tool setting information.

In addition, since conditions of the tool change with production, it may be desirable to continuously manage previously held tool condition information in some way, when the tool is reattached to another machine. For example, when a tool must be exchanged after the operating time of the tool has elapsed for a certain period of time, it may be desirable to accumulate and manage the operating time even if the tool is reattached to the different machine. As a means to simplify the management of the tool, a file containing the tool condition information can be read by another controller, but there is a demerit in that the file needs to be output in advance.

Therefore, there is demand for a technique to simplify the setting or management of the tool.

One aspect of the present disclosure provides a controller configured to control a tool having a memory detachably attached to a machine, the controller comprising: a tool information reading section configured to read at least one of tool setting information and tool condition information written to the memory of the tool; and a tool setting section configured to set the tool based on at least one of the read tool setting information and the read tool condition information, wherein the tool is driven by a motor having an encoder, and the memory is attached to the encoder.

A further aspect of the present disclosure provides a control system comprising: a first controller configured to control a tool having a memory detachably attached to a first machine; and a second controller configured to control the tool detachably attached to a second machine, wherein the first controller writes at least one of tool setting information and tool condition information to the memory of the tool, and the second controller reads at least one of the read tool setting information and the read tool condition information.

A still further aspect of the present disclosure provides a tool detachably attached to a machine and controlled by a controller, wherein the tool comprises a memory to which at least one of tool setting information and tool condition information is written by the controller, and from which at least one of the tool setting information and the tool condition information is read by the controller.

According to the one aspect of the present disclosure, since the tool can be automatically set in the controller based on at least one of the tool setting information and the tool condition information written in the memory of the tool, setting of the tool can be simplified.

According to the further aspect of the present disclosure, the first controller writes at least one of tool setting information and tool condition information to the memory of the tool, and the second controller reads at least one of the written tool setting information and the written tool condition information. Therefore, the tool can be continuously managed even when the tool is reattached from the first machine to the second machine.

According to the still further aspect of the present disclosure, the tool comprises a memory to which at least one of tool setting information and tool condition information is written by the controller, and from which at least one of the tool setting information and the tool condition information is read by the controller. Therefore, setting or management of the tool can be simplified.

### BRIEF DESCRIPTION OF DRAWINGS

FIG. 1 is a schematic view showing an example of a machine, a tool and a controller.

FIG. 2 is a block diagram showing an example of a configuration of the machine, the tool and the controller.

FIG. 3 is a conceptual diagram showing an example of reading of tool setting information and tool condition information.

FIG. 4 is a conceptual diagram showing an example of writing of tool setting information and tool condition information.

FIG. 5 is a block diagram showing an example of a configuration of a control system.

### DETAILED DESCRIPTION OF EMBODIMENTS OF THE INVENTION

The embodiments of the present disclosure will be described in detail below with reference to the attached drawings. In the drawings, identical or similar constituent elements have been assigned the same or similar reference signs. Furthermore, the embodiments described below do not limit the technical scope of the invention described in the claims or the definitions of the terms.

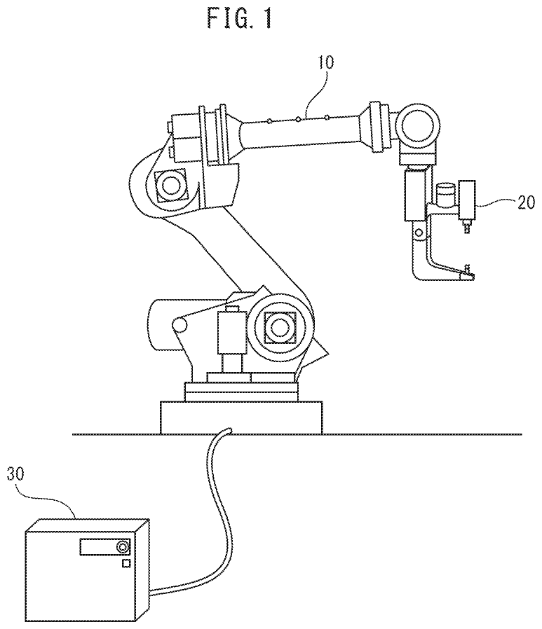

FIG. 1 shows an example of a machine 10, a tool 20 and a controller (control device) 30. For example, the machine 1 is a robot, but may be another machine such as a machine tool or construction machine. The tool 20 may be a tool having a memory detachably attached to the machine 10, for example, may be a welding tool (spot welding gun). However, the tool 20 may be another tool such as a sealing tool, a panting tool or a hand. The machine 10 and the tool 20 are connected to a controller 30 via wire or wireless. For example, the controller 30 may be a computing device having a processor and/or an integrated circuit such as a CPU (central processing unit), an ASIC (application specific integrated circuit), and an FPGA (field-programmable gate array). The controller 30 controls the machine 10 and the tool 20, but may be a controller which controls only the tool 20.

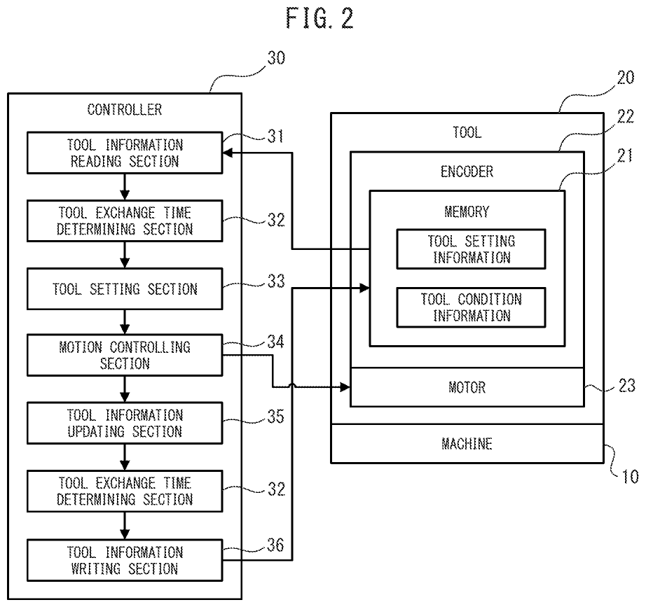

FIG. 2 shows an example of a configuration of the machine 10, the tool 20 and the controller 30. The tool 20 has a memory 21 configured to store at least one of tool setting information and tool condition information. The memory 21 may be, for example, a non-volatile memory, or may be an existing memory attached to an encoder 22 when the tool 20 is driven by a motor 23 with an encoder such as a servomotor. The encoder 22 may be, for example, an optical encoder, but may also be a mechanical, optical, magnetic, or electromagnetic induction encoder. In general, the memory 21 of the encoder 22 stores a rotational position, a rotational speed, an amount of rotation, a direction of rotation, etc. The memory 21 also may store the tool setting information and the tool condition information. By using the memory 21 of the encoder 22, there is no need to provide a tool communication means to the tool 20 separately from a connection line of the motor 23 with the encoder. Therefore, the tool 20 can be set or managed by simply connecting the motor 23 with encoder to the controller 30. In other words, the setting or management of the tool 20 can be simplified at the same cost as the prior art, without requiring additional equipment or operations.

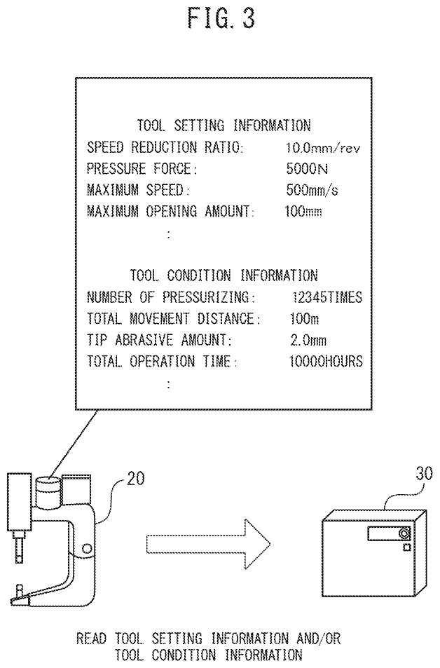

FIG. 3 is an example of reading of the tool setting information and the tool condition information. The tool setting information includes, for example, a speed reduction ratio, a pressure force, a maximum speed, a maximum opening amount, etc., and the tool condition information includes, for example, a number of pressurizations, a total movement distance, a tip abrasive amount, a total operation time, etc. The controller 30 may have a tool information reading section 31 configured to read at least one of the tool setting information and the tool condition information written in the memory 21 of the tool 20, and a tool setting section 33 configured to set the tool 20 based on at least one of the read tool setting information and the read tool condition information (see FIG. 2). Since the tool 20 itself has the tool setting information, there is no need to separately obtain the tool setting information from the manufacturer of the tool 20, prepare setting data in advance, or separately manage the setting data. In other words, since the tool 20 can be automatically set in the controller 30, the setting of the tool 20 can be simplified. The timing of reading the tool setting information and/or the tool condition information may be when the tool 20 is connected to the controller 30, or may be when the tool 20 is actually used. By reading the information when the tool is connected, plug-and-play of the tool 20 becomes possible.

The controller 30 has a motion controlling section 34 configured to control the motion of the tool 20 based on the read tool setting information. For example, the motion controlling section 34 controls the speed of the tool based on the speed reduction ration and the maximum speed, etc., and controls the position of the tool based on the pressure force and the maximum opening amount, etc. Further, the controller 30 may have a tool information updating section 35 configured to update the tool condition information. For example, the tool information updating section 35 may updates the number of pressurizing, the total movement distance and the total operation time, etc., corresponding to the motion of the tool 20. In addition, the controller 30 may have a tool exchange time determining section 32 configured to determine when to exchange the tool based on the read or updated tool condition information. The tool exchange time determining section 32 may determine the tool exchange time based on thresholds of the number of pressurizing, the total movement distance, and the total operation time, etc., and notify the user or an external device of the determination result.

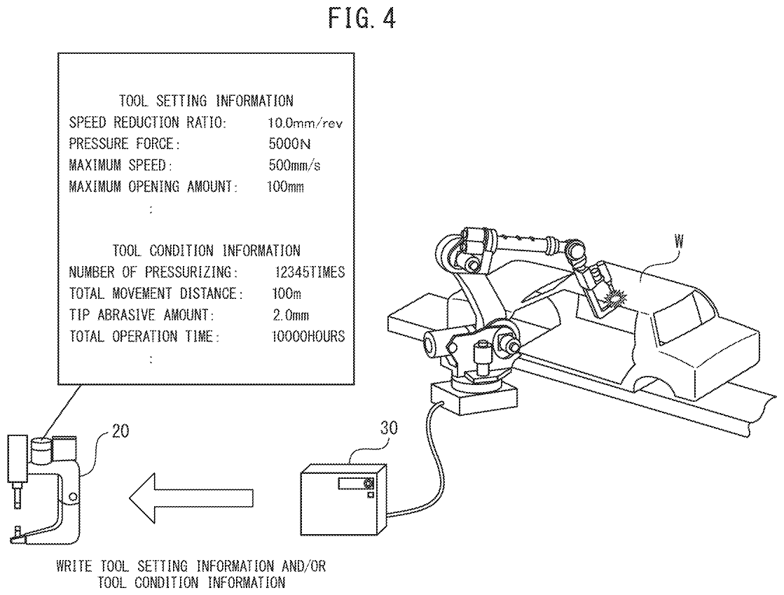

FIG. 4 is an example of writing of the tool setting information and the tool condition information. The controller 30 may have a tool information writing section 36 configured to write at least one of the tool setting information and the tool condition information to the memory 21 of the tool 20. For example, the tool information writing section 36 may writes the updated tool condition information to the memory 21 of the tool 20. Since the tool 20 itself has the tool condition information, there is no need to separately manage the tool condition information, and management of the tool 20 can be simplified. For example, the timing of writing the tool condition information may be during the production of the workpiece W (for example, during the tool is operated), or may be when the operation of the tool 20 is stopped. In addition, the tool setting information may be previously written when the tool 20 is manufactured or shipped. However, when the tool 20 is initialized in the controller 30 from an operation panel, for example, the tool setting information may be written to the memory 21 of the tool 20 at the time of the tool initialization.

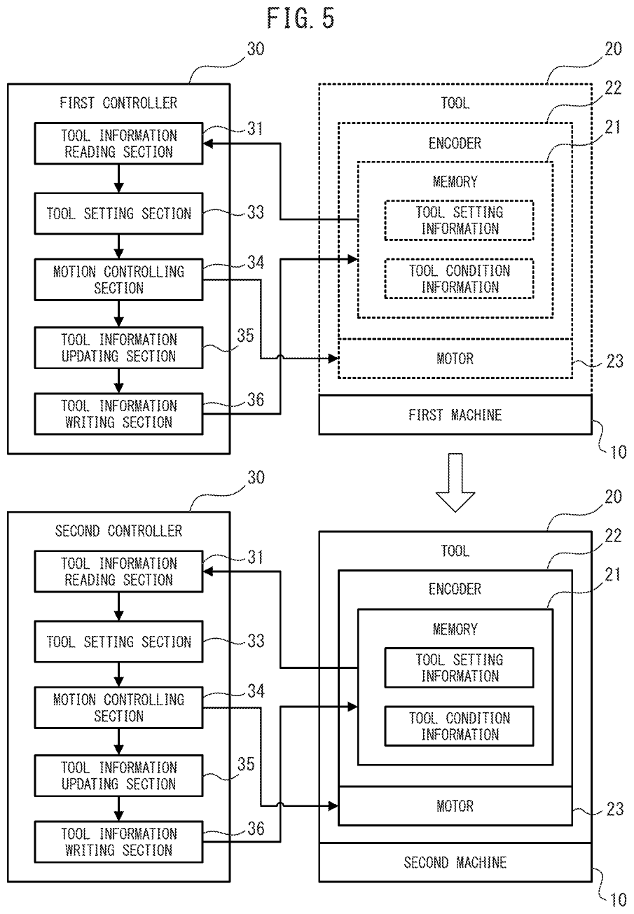

FIG. 5 is a block diagram showing an example of a configuration of a control system. For example, the control system includes a first controller 30 configured to control the tool 20 having the memory detachably attached to the first machine 10; and the second controller 30 configured to control the tool 20 detachably attached to the second machine 10. The first controller 30 writes at least one of the tool setting information and the tool condition information to the memory 21 of the tool 20. After the tool 20 is reattached from the first machine 10 to the second machine 10, the second controller reads at least one of the written tool setting information and the written tool condition information. The second controller 30 may set the tool based on the read tool setting information, or update the tool condition information corresponding to the motion of the tool 20, or determine the exchange time of the tool 20 based on the read or updated tool condition information. Further, the second controller 30 writes at least one of the tool setting information and the tool condition information to the memory 21 of the tool 20. By virtue of this, even when the tool 20 is reattached from the first machine 10 to the second machine 10, the tool 20 can be continuously managed. The first machine 10 and the second machine 10 are, for example, robots as described above, but may be other machines such as machine tools.

As described above, the tool 20 includes the memory 21 to which at least one of tool setting information and tool condition information is written by the controller 30, and from which at least one of the tool setting information and the tool condition information is read by the controller 30. Since the tool 20 itself has at least one of tool setting information and tool condition information, the setting or management of the tool 20 can be simplified. In addition, by using the memory 21 of the encoder 22, the setting or management of the tool 20 can be performed simply by connecting the motor 23 with the encoder to the controller 30 (i.e., without requiring additional devices or operations, at the same cost as in the prior art).

According to the above embodiments, the setting or management of the tool can be simplified. The programs executed by the processor described above may be recorded and provided on a computer-readable non-transitory recording medium such as a CD-ROM, or may be distributed and provided wired or wirelessly from a server device on a WAN (wide area network) or LAN (local area network).

Although the various embodiments are described herein, it should be noted that the present invention is not limited to the above embodiments, and various modifications can be performed within the scope of the claims.

### REFERENCE SIGNS LIST

10 machine
20 tool
21 memory
22 encoder
30 controller
31 tool information reading section
32 tool exchange time judging section
33 tool setting section
34 motion controlling section
35 tool information updating section
36 tool information writing section
W workpiece

1. A controller configured to control a tool having a memory detachably attached to a machine, the controller comprising:
a tool information reading section configured to read at least one of tool setting information and tool condition information written to the memory of the tool; and
a tool setting section configured to set the tool based on at least one of the read tool setting information and the read tool condition information,
wherein the tool is driven by a motor having an encoder, and the memory is attached to the encoder.

2. The controller according to claim 1, further comprising a tool information updating section configured to update the tool condition information.

3. The controller according to claim 1, further comprising a tool information writing section configured to write at least one of the tool setting information and the tool condition information to the memory of the tool.

4. The controller according to claim 3, wherein the tool information writing section writes the tool condition information when the tool is operated or stopped.

5. The controller according to claim 1, wherein the tool information reading section reads the tool setting information when the tool is connected or used.

6. The controller according to claim 1, comprising a tool exchange time determining section configured to determine an exchange time of the tool based on the tool condition information.

7. A control system comprising:
a first controller configured to control a tool having a memory detachably attached to a first machine; and
a second controller configured to control the tool detachably attached to a second machine,
wherein the first controller writes at least one of tool setting information and tool condition information to the memory of the tool, and
the second controller reads at least one of the written tool setting information and the written tool condition information.

8. The control system according to claim 7, wherein the second controller sets the tool based on the read tool setting information, or updates the tool condition information, or writes at least one of the tool setting information and the tool condition information.

9. A tool detachably attached to a machine and controlled by a controller, wherein the tool comprises a memory to which at least one of tool setting information and tool condition information is written by the controller, and from which at least one of the tool setting information and the tool condition information is read by the controller.
